(19) United States
(12) Patent Application Publication
(10) Pub. No.: US 2025/0165802 A1
(43) Pub. Date: May 22, 2025

(54) COLLABORATIVE CACHING FRAMEWORK FOR MULTI-EDGE SYSTEMS WITH ROBUST FEDERATED DEEP LEARNING

(71) Applicant: FUZHOU UNIVERSITY, Fuzhou (CN)

(72) Inventors: Zheyi CHEN, Fuzhou (CN); Jie LIANG, Fuzhou (CN); Luying ZHONG, Fuzhou (CN); Jiayu ZHENG, Fuzhou (CN)

(73) Assignee: FUZHOU UNIVERSITY, Fuzhou (CN)

(21) Appl. No.: 18/408,610

(22) Filed: Jan. 10, 2024

Related U.S. Application Data
(63) Continuation of application No. PCT/CN2023/132497, filed on Nov. 20, 2023.

(51) Int. Cl. G06N 3/098

(52) U.S. Cl. CPC G06N 3/098

(57) ABSTRACT

A Collaborative Caching Framework for Multi-edge Systems with Robust Federated Deep Learning is provided. First, we design a new partitioning mechanism for multi-dimensional cache space, enabling precise content recommendations in user classification intervals. Next, we develop a VQ-VAE-based accurate prediction for content popularity by overcoming posterior collapse. Finally, we create a new training mode and proactive cache replacement strategy based on robust federated deep learning. Specifically, residual-based detection for adversarial model updates and similarity-based federated aggregation are integrated to avoid the model destruction caused by adversarial updates, which enables the proactive cache replacement adapting to optimized cache resources and thus enhances cache performance. Using real-world testbed and MovieLens datasets, extensive experiments verify that RoCoCache achieves higher cache hit rates and efficiency than benchmark methods while ensuring better robustness. Moreover, we demonstrate the effectiveness of the components designed in RoCoCache via ablation experiments.

### CROSS REFERENCE TO THE RELATED APPLICATIONS

This application is the continuation application of International Application No. PCT/CN2023/132497, filed on Nov. 20, 2023, the entire contents of which are incorporated herein by reference.

### TECHNICAL FIELD

The present invention belongs to the technical field of Mobile Edge Computing, in particular relates to a Collaborative Caching Framework for Multi-edge Systems with Robust Federated Deep Learning.

### BACKGROUND

With the tremendous development of the 5G technique, massive intelligent applications are expanding across industrial manufacturing, digital economy, vehicle networking, and smart cities. For cloud computing, the tasks and data generated by the applications are uploaded to the remote cloud for processing, causing serious network congestion and service delay. To relieve this problem, the emerging Mobile Edge Computing (MEC) deploys computing and storage resources at the network edge that is close to end devices, offering sturdy support of real-time computing and data storage for end intelligent applications. Thus, MEC nodes can perform various management operations such as signal processing, distributed caching, and wireless resource collaboration. Among these operations, the distributed caching caches user-interested content on MEC nodes, aiming to reduce access delay and data duplication storage, thus enhancing user experience and saving system costs. However, the cache performance is commonly limited by the size of cache space and overheads. Therefore, how to effectively utilize the MEC cache space and improve cache performance has attracted extensive attention from both academia and industry. Generally, cache performance is constrained by many factors including cache size, content relevance, cache partitioning, and cache replacement. It is worth noting that it would be helpful to find the optimal configuration of cache resources via exploring the potential connection between user and content characteristics in the multi-dimensional space, which will enhance the hit rate of user-accessed resources. Also, the multi-dimensional partitioning of the cache space assists MEC systems in providing more accurate recommendations of popular content to users. However, it is still highly challenging to effectively explore and partition the multi-dimensional cache space.

Multi-edge collaborative caching works as a feasible mechanism to further optimize cache resource configuration and reduce service delay. Users can find their requested contents from other MEC nodes that perform collaborative caching if their connected MEC nodes do not match their requests. Nevertheless, most of the existing studies cannot well address the problems of inefficient multi-edge collaboration and irrational cache resource configuration. As a distributed training framework, Federated Learning (FL) is regarded as a promising solution to optimize the above problems. Following the basic idea of FL, MEC nodes collaborate to train a global model by uploading model parameters without revealing raw data. However, in complex MEC environments, unintentional model corruption or adversarial model interference with malicious intention may result in model training inability and degraded quality of the global model. Specifically, unintentional model corruption may happen due to noisy training labels, insufficient data samples, and unintentionally uploaded models with low quality. Malicious MEC nodes may deliberately launch adversarial attacks to tamper models such as Byzantine and Backdoor attacks. The key challenges of applying FL to deal with the problem of multi-edge collaborative caching are summarized below.
Discrete user features and diverse content requests. Different users may have various content preferences due to their discrete features. Therefore, it is challenging to find the potential connections between the discrete user feature distribution and diverse content requests.
Model scalability. As the increasing number of end devices, there will be more data with discrete distribution, causing high computation and communication overheads for the caching in the scenario with a single MEC node. However, the traditional centralized machine learning framework reveals limited model scalability and cannot efficiently handle this issue.
Model robustness. MEC nodes may unintentionally upload low-quality models or be subjected to adversarial attacks by some malicious nodes, leading to seriously degraded robustness during the model updating.

### SUMMARY

The purpose of the present invention is to provide a Collaborative Caching Framework for Multi-edge Systems with Robust Federated Deep Learning; wherein the Collaborative Caching Framework for Multi-edge Systems which consists of M MEC nodes, each contains a MEC server and a base station, donated by the set E={e₁, e₂, . . . , eₘ, . . . , e_{M}}, and N users, donated by the set U={u₁, u₂, . . . , uₙ, . . . , U_{N}}; the caching space of MEC nodes is donated as the set C={C₁, C₂, . . . , Cₘ, . . . , C_{M}}; each user is connected to a MEC node, and they communicate with each other via the wireless link provided by the associated base station; furthermore, the communications among MEC nodes and between MEC nodes and the cloud data center are conducted via the backhaul link; the caching space status of each MEC node is periodically broadcast to the other MEC nodes within the proposed system; moreover, the content library of the cloud data center, denoted by F={f₁, f₂, . . . , fᵢ, . . . , f_{I}}, where I indicates the number of accessible contents; It is noted that users are discretely distributed in the service zone of each edge node.

When the user uₙ sends a request for the content fᵢ to its connected MEC node, the workflow is given as follows;
Step 1: the current MEC node checks whether it has cached fᵢ; if fᵢ is cached, the MEC node will send it to uₙ directly; otherwise, it goes to Step 2;
Step 2: the current MEC node searches for whether there exists a collaborative MEC node that caches fᵢ; if there exists, the collaborative MEC node will forward fᵢ to the current MEC node via the backhaul link, and then fᵢ will be sent to uₙ; otherwise, it goes to Step 3;
Step 3: if no collaborative MEC node caches fᵢ, the content library in the cloud data center will provide fᵢ and forward it to the current MEC node through the backhaul link, and then fᵢ will be sent to uₙ.

The popularity of fᵢ on the MEC node eₘ is defined as

$${P}_{i , m} = \frac{{req}_{i , m}}{{req}_{m}} \qquad ( 1 )$$

where req_{i,m} is the number of requests for fᵢ received by eₘ, and reqₘ is the total number of requests received by eₘ;

The proposed RoCoCache enables precise prediction of content popularity; to evaluate the prediction accuracy, the global loss function is defined as

$$J ( {w}^{( r )} ) = {\sum }_{m = 1}^{M} \frac{{req}_{m}}{req} M S {E}_{m} ( {w}_{m}^{( r )} ) \qquad ( 2 )$$

Where r indicates the FL communication round, w(r) is the parameter of the global prediction model, req is the total number of requests received by all MEC nodes, wₘ^{(r)} is the parameter of a local prediction model, and Mean-Square Error (MSE) is defined as

$$M S {E}_{m} ( {w}_{m}^{( r )} ) = \frac{1}{I} {\sum }_{i = 1}^{I} {( {y}_{i , m} ( {w}_{m}^{( r )} ) - {P}_{i , m} ( r ) )}^{2} \qquad ( 3 )$$

where [symbol] _{i,m}(wₘ^{(r)} is the predicted popularity value of fᵢ on eₘ and P_{i,m}(r) is the actual value;
moreover, the cache hit rate is defined as

$$H = \frac{{\sum }_{m = 1}^{M} {\sum }_{i = 1}^{N} {θ}_{m} ( {f}_{i} )}{{\sum }_{m = 1}^{M} {req}_{m}} \times 100 \% \qquad ( 4 )$$

Where θₘ(fᵢ) indicates whether eₘ caches the content requested by users or not, and it is defined as

$${θ}_{m} ( {f}_{i} ) = \{ \begin{matrix}1 , & if {f}_{i} in {C}_{m} \\ 0 , & otherwise\end{matrix} . \qquad ( 5 )$$

Proposing a user partitioning method based on multi-dimensional user features including gender, age, and occupation, which are mapped to coordinate axes, denoted by Θ={l₁, l₂, . . . , lₜ, . . . , l_{T}}; at the initial stage (Grade=0), all users with different features are placed within the same user interval (h₀); if the number of users in h₀ exceeds the threshold ζ(Grade), it will be equally divided into 2^{T} user intervals along each dimension, where the length of each divided dimension will be halved (lₜ=lₜ/2); ζ(Grade) determines the number of users in a user interval; when ζ(Grade) is larger, there are more users in each user interval, which cannot well reflect the unique preferences of different users; when ζ(Grade) is smaller, there are fewer users in each user interval, which may lead to inaccurate cache prediction; to achieve adaptive partitioning of user intervals and capture the potential relationships between interval users and their preferred contents, we set ζ(Grade)=α2^{Grade}, where α is a hyper-parameter; the partitioned user intervals are denoted as H={h₁, h₂, . . . , hₛ, . . . , h_{S}}, where S is the number of user intervals; the partitioning may continue and go to the following stages (e.g., Grade=1, 2, . . . ) according to performance requirements.

The user activity and memory access interval are defined as

$$active ( {h}_{s} ) = \frac{{req}_{s}}{{req}_{m}} \qquad ( 6 )$$

$$diverge ( {h}_{s} ) = \frac{Γ ( {h}_{s} )}{I} \qquad ( 7 )$$

where reqₛ is the number of user requests and Γ(hₛ) is the memory access interval of hₛ;

Considering the above factors, the size of cache space allocated to hₛ is defined as

$${cache}_{s} = \frac{φ ( num ( {h}_{s} ) , active ( {h}_{s} ) , diverge ( {h}_{s} ) ) \times {cache}_{m}}{{\sum }_{s = 1}^{S} φ ( num ( {h}_{s} ) , active ( {h}_{s} ) , diverge ( {h}_{s} ) )} \qquad ( 8 )$$

where cacheₘ indicates the size of cache space on the MEC node connected to hₛ.

The user request matrix X contains historical information of user-requested contents on MEC nodes, which is defined as

$$X = {[ {x}_{1} , … , {x}_{n} , … , {x}_{N} ]}^{T} ∈ {ℝ}^{N \times I} \qquad ( 9 )$$

where 1≤n≤N and with n presenting the number of users connected to a MEC node; xₙ=[xₙ¹, . . . , xₙⁱ, . . . , xₙ^{I}]^{T} indicates the content request record of the user n, where 1≤i≤I and i is the index of the content library; xₙⁱ=1 indicates the successful content request; xₙⁱ=0 indicates either a failed content request or the content that is not of interest, and these two cases are hard to be distinguished, leading to inaccurate prediction; to solve this issue, we supplement and calibrate the matrix X;
   In VQ-VAE, the implicit embedded space is defined as v∈ [symbol] ^{K×D},
where K is the space size and D is the dimension of the embedded vector; thus, there are K embedded vectors vₖ∈ [symbol] ^{D} (k∈1, 2, 3, . . . , K); the VQ-VAE inputs xₙ and outputs tᵥ(xₙ) via the encoder network; next, discrete hidden variable t is calculated by the nearest neighbor algorithm, and the posterior probability distribution q(t|xₙ) is one-hot encoding, which is defined as

$$q ( t = k \vert {x}_{n} ) = \{ \begin{matrix}1 , & for k = arg {min}_{j} {‖ {t}_{v} ( {x}_{n} ) - {v}_{j} ‖}_{2} \\ 0 , & otherwise\end{matrix} \qquad ( 10 )$$

The input of the decoder is defined as

$${t}_{q} ( {x}_{n} ) = {v}_{k} \qquad ( 11 )$$

where k is the index of the decoder input, and it is defined as

$$k = arg {min}_{j} {‖ {t}_{v} ( {x}_{n} ) - {v}_{j} ‖}_{2} \qquad ( 12 )$$

To address the problem of gradient collapse caused by introducing the implicit embedded space, we replicate the gradient ∇_{z}L from the decoder network to the encoder network during the back-propagation;

When training the VQ-VAE, the loss function is defined as

$$L = log p ( {x}_{n} \vert {t}_{q} ( {x}_{n} ) ) + {‖ sg [ {t}_{v} ( {x}_{n} ) ] - v ‖}_{2}^{2} + λ {‖ {t}_{v} ( {x}_{n} ) - sg [ v ] ‖}_{2}^{2} , \qquad ( 13 )$$

where log p(xₙ|t_{q}(xₙ) is the reconstruction loss, aiming to optimize the encoder and decoder networks; since the back-propagation gradient is directly replicated to the encoder network, the loss log p(xₙ|t_{q}(xₙ)) is not considered; in ∥sg[tᵥ(xₙ)]−v∥₂², L2 error is used to drive vₖ towards tᵥ(xₙ), aiming to optimize the implicit embedded space; λ∥tₙ(xₙ)−sg[v]∥₂² is to prevent the encoder output from exceeding the scope of the implicit embedding space, where λ depends on the reconstruction loss, and sg is the stop-gradient operator that is constant with the partial derivative of 0 during the forward propagation;

Next, the log-likelihood function is defined as

$$log p ( {x}_{n} ) \approx log p ( {x}_{n} \vert {t}_{q} ( {x}_{n} ) ) p ( {t}_{q} ( {x}_{n} ) ) \qquad ( 14 )$$

According to Jensen's Inequality, Eq. (13) is rewritten as

$$log p ( {x}_{n} ) \geq log p ( {x}_{n} \vert {t}_{q} ( {x}_{n} ) ) p ( {t}_{q} ( {x}_{n} ) ) . \qquad ( 15 )$$

First combine the model parameters from all MEC nodes into a matrix R∈ [symbol] ^{M×θ}, which is defined as

$${R}_{m , :} = \frac{‖ {w}_{m}^{\text{(*} )} - {w}_{m}^{( 0 )} ‖}{M} \qquad ( 16 )$$

$${w}_{m}^{\text{(*} )} = {w}_{m}^{( 0 )} - \frac{1}{M} {{\sum }^{M}}_{m = 1} \frac{\partial L ( {w}_{m} ; {d}_{m} )}{\partial w} \qquad ( 17 )$$

$${w}_{m}^{( 0 )} - {w}_{m}^{\text{(*} )} = \frac{1}{M} {\sum }_{m = 1}^{M} \frac{\partial L ( {w}_{m} ; {d}_{m} )}{\partial w} \qquad ( 18 )$$

where the local training model is parameterized by wₘ, wₘ^{(*)} is the updated local model, and dₘ is the training data;

Next, we arrange the elements of each column in R in descending order, retain their sorted positions, and transform them into \tilde{R}; for example, R(5.3, 6.7, 0.7,0.4)→\tilde{R}(2, 1, 3, 4); specifically, the mean and standard deviation (STD) of \tilde{R} are defined as

$${mean}_{m} = \frac{1}{θ} {\sum }_{ϑ = 1}^{θ} {\tilde{R}}_{m , ϑ} \qquad ( 19 )$$

$${std}_{m} = \sqrt{\frac{1}{θ} {\sum }_{ϑ = 1}^{θ} {( {\tilde{R}}_{m , ϑ} - {mean}_{m} )}^{2}} \qquad ( 20 )$$

Following the mean and STD, we can divide the normal and adversarial model updates into two clusters through the K-means, where the adversarial model updates can be easily identified by the proposed residual-based detection; thus, the MEC nodes that offer normal model updates can be filtered, denoted by E′={e₁, e₂, . . . , e_{M′}}; to avoid the model destruction caused by adversarial model updates, we design a similarity-based federated aggregation method; specifically, we adopt the canonical correlation analysis (CCA) to measure the similarity between the model updates of each MEC node and the average one, which determines the weights of different model updates when performing federated aggregation; this process is described as

$${w}^{r + 1} = ( 1 - β ) {w}^{r} + β {\sum }_{m = 1}^{{M}^{′}} \frac{{w}_{m}^{r}}{\vert d \vert} * τ \qquad ( 21 )$$

where τ indicates the similarity score.

Based on the proposed RFDL, design a proactive cache replacement strategy with multi-edge collaboration; for each MEC node, initialize the cache space cache temp and set of user intervals H through the multi-dimensional cache space partitioning; while cacheₜₑₘₚ≥0, and the user-interest contents will be placed into the temporary cache library Cₜₑₘₚ; to avoid the cache redundancy caused by overlapping userinterest contents in different intervals, replace Cₜₑₘₚ by Cₛ that selects cacheₕ most popular contents in the current user interval hₛ from Cₜₑₘₚ;next, remove the duplicates in the cache library Cₘ on each MEC node and update the available cache space; the above steps will be iterated until the cache space is fully occupied.

Compared with the prior art, the present invention has the following beneficial effects:

Through the ablation experiments, we verify that the designs of multidimensional cache space partition and collaborative caching in RoCoCache can effectively improve the cache performance. Moreover, the RoCoCache exhibits both excellent training and cache efficiency under various scenarios with different numbers of MEC nodes and cache space sizes. Besides, the RoCoCache is able to accurately identify adversarial model updates in complex network environments, demonstrating its good robustness.

### BRIEF DESCRIPTION OF THE DRAWINGS

FIG. 1 is the proposed multi-edge collaborative caching system;

FIG. 2 is an example of multi-dimensional user partitioning;

FIG. 3 shows content popularity prediction based on VQ-VAE;

FIG. 4 shows residual-based detection;

FIG. 5 shows real-world testbed for RoCoCache;

FIG. 6 shows comparison between the RoCoCache and other methods;

FIG. 7 shows ablation experiments on multi-dimensional cache space partitioning and collaborative caching;

FIG. 8 shows convergence of the RoCoCache;

FIG. 9 shows training efficiency of the RoCoCache;

FIG. 10 shows residual-based detection for various attacks;

FIG. 11 shows performance of the RoCoCache under different attacks and defenses.

### DETAILED DESCRIPTION OF THE EMBODIMENTS

The technical solution of the present invention is described in detail in combination with the accompany drawings.

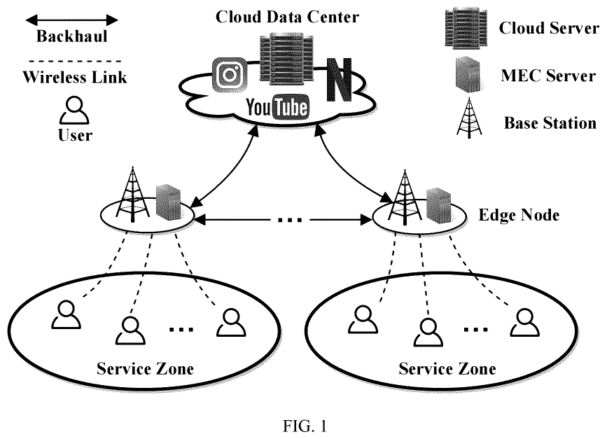

Proposed in the present invention is a Collaborative Caching Framework for Multi-edge Systems with Robust Federated Deep Learning. Framework is as shown in FIG. 1.

The method specifically comprises the following design process:

To address these important challenges, we propose RoCoCache, a novel collaborative caching framework for multi-edge systems with robust federated deep learning. The main contributions of this application are summarized as follows.
We propose a novel partitioning mechanism for multidimensional MEC cache space. The mechanism consists of multi-dimensional user partitioning and cache space partitioning, with the consideration of user features, activities, and access intervals, aiming to perceptually optimize cache resources. Meanwhile, users can receive accurate content recommendations in their classification interval.
We design a new content popularity prediction algorithm with Vector-Quantized Variational Auto-Encoder (VQ-VAE). First, the algorithm learns the implicit embedding space consisting of discrete vectors. Next, it employs the nearest neighbor to find discrete implicit vectors, assisting the decoder in generating the user request matrix. Thus, we solve the posterior collapsing issue and enhance the prediction accuracy of content popularity.
We design a novel training mode based on Robust Federated Deep Learning (RFDL). Using the user request data stored on each MEC node, local models are aggregated to generate a globally-shared model. It is worth noting that a residual-based detection method is proposed to accurately capture adversarial model updates. Meanwhile, a similarity-based FL aggregation method is designed to avoid the destruction of the globally-shared model caused by the adversarial updating.
We develop a new proactive cache replacement strategy for the proposed collaborative caching framework, implementing the iterative update of cache contents across different user cache spaces. Based on RFDL, the developed replacement strategy can well adapt to optimized cache resource configuration and improve the performance of multi-edge collaborative caching.

The proposed multi-edge collaborative caching system is shown in FIG. 1, which consists of M MEC nodes (each contains a MEC server and a base station), donated by the set E ={e₁, e₂, . . . , eₘ, . . . , e_{M}}, and N users, donated by the set U={u₁, u₂, . . . , uₙ, . . . , U_{N}}. The caching space of MEC nodes is donated as the set C={C₁, C₂, . . . , Cₘ, . . . , C_{M}}. Each user is connected to a MEC node, and they communicate with each other via the wireless link provided by the associated base station. Furthermore, the communications among MEC nodes and between MEC nodes and the cloud data center are conducted via the backhaul link. The caching space status of each MEC node is periodically broadcast to the other MEC nodes within the proposed system. Moreover, the content library of the cloud data center, denoted by F={f₁, f₂, . . . , fᵢ, . . . , f_{I}}, where I indicates the number of accessible contents. It is noted that users are discretely distributed in the service zone of each edge node. When the user uₙ sends a request for the content fᵢ to its connected MEC node, the workflow is given as follows.
Step 1: The current MEC node checks whether it has cached fᵢ. If fᵢ is cached, the MEC node will send it to uₙ directly. Otherwise, it goes to Step 2.
Step 2: The current MEC node searches for whether there exists a collaborative MEC node that caches fᵢ. If there exists, the collaborative MEC node will forward fᵢ to the current MEC node via the backhaul link, and then fᵢ will be sent to uₙ. Otherwise, it goes to Step 3.
Step 3: If no collaborative MEC node caches fᵢ, the content library in the cloud data center will provide fᵢ and forward it to the current MEC node through the backhaul link, and then fᵢ will be sent to uₙ.

In the scenario of multi-edge collaborative caching, users' content requests are dynamic and reveal spatio-temporal dependencies. Commonly, the cache hit rate can be greatly improved by accurately predicting content popularity and then caching the user-interest contents into the cache space of MEC nodes. Specifically, the popularity of fᵢ on the MEC node eₘ is defined as

$${P}_{i , m} = \frac{{req}_{i , m}}{{req}_{m}} \qquad ( 1 )$$

where req_{i, m} is the number of requests for fᵢ received by eₘ, and reqₘ is the total number of requests received by eₘ.

The proposed RoCoCache enables precise prediction of content popularity. To evaluate the prediction accuracy, the global loss function is defined as

$$J ( {w}^{( r )} ) = {\sum }_{m = 1}^{M} \frac{{req}_{m}}{req} {MSE}_{m} ( {w}_{m}^{( r )} ) \qquad ( 2 )$$

Where r indicates the FL communication round, w^{(r)} is the parameter of the global prediction model, req is the total number of requests received by all MEC nodes, wₘ^{(r)} is the parameter of a local prediction model, and Mean-Square Error (MSE) is defined as

$${MSE}_{m} ( {w}_{m}^{( r )} ) = \frac{1}{I} {\sum }_{i = 1}^{I} {( {y}_{i , m} ( {w}_{m}^{( r )} ) - {P}_{i , m} ( r ) )}^{2} \qquad ( 3 )$$

where [symbol] _{i,m}(wₘ^{(r)} is the predicted popularity value of fᵢ on eₘ and P_{i,m}(r) is the actual value.

Moreover, the cache hit rate is defined as

$$H = \frac{{\sum }_{m = 1}^{M} {\sum }_{i = 1}^{N} {θ}_{m} ( {f}_{i} )}{{\sum }_{m = 1}^{M} {req}_{m}} \times 100 \% \qquad ( 4 )$$

Where θₘ(fᵢ) indicates whether eₘ caches the content requested by users or not, and it is defined as

$${θ}_{m} ( {f}_{i} ) = \{ \begin{matrix}1 , & if {f}_{i} in {C}_{m} \\ 0 , & otherwise\end{matrix} \qquad ( 5 )$$

The cache performance might be affected by many factors including cache resource configuration, content popularity, model robustness, and cache replacement strategy. With the comprehensive consideration of these factors, the proposed RoCoCache is able to effectively improve the cache performance in a multi-edge collaborative caching system.

Based on the proposed system model and problem formulation, we propose RoCoCache, a novel collaborative caching framework for multi-edge systems with RFDL. First, we perceptually optimize the cache space of MEC nodes via a new multi-dimensional cache space partitioning and determine the proper size of cache space for interval users. Next, we design a new VQ-VAE to learn the implicit embedded space consisting of discrete vectors. In VQ-VAE, the decoder uses the nearest neighbor to find discrete hidden vectors, and then it generates the user request matrix that has been calibrated, thereby improving the prediction accuracy of content popularity. Next, we design a novel training mode based on RFDL to improve model scalability and robustness. In this design, we use a residual-based detection method to capture adversarial model updates. And a similarity-based FL aggregation method is utilized to avoid the damage of the globally-shared model caused by adversarial updating. Finally, we design a proactive cache replacement strategy based on RFDL to better fit the optimized cache resource configuration and improve the performance of multi-edge collaborative caching.

### A. Multi-dimensional Cache Space Partitioning

Multi-dimensional cache space partitioning comprised two main components: multi-dimensional user partitioning and cache space partitioning. First, we classify and segment feature groups with various numbers of users, where user-interest contents are individually cached for different groups. Next, based on the established classification, the cache space is perceptually optimized based on user features, user activities, and memory access intervals.

### (1) Multi-Dimensional User Partitioning

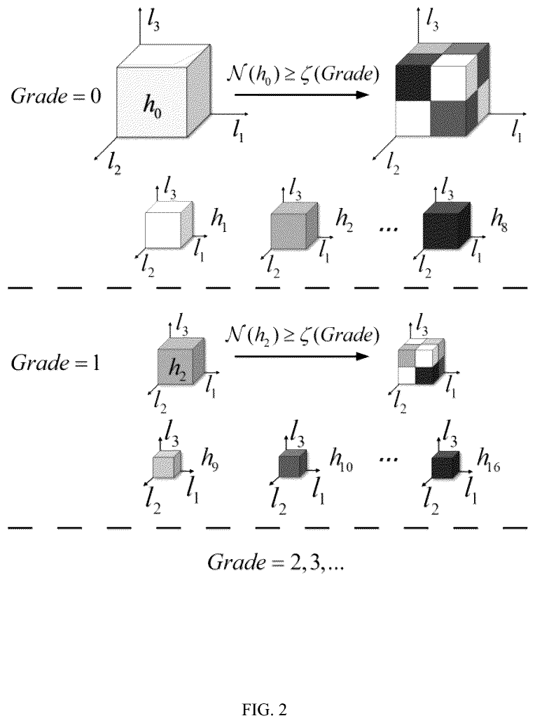

To a certain extent, user features reflect the user preference for cache contents. As shown in FIG. 2, to accurately predict user preferences, we propose a user partitioning method based on multi-dimensional user features including gender, age, and occupation, which are mapped to coordinate axes, denoted by Θ={l₁, l₂, . . . , lₜ, . . . , l_{T}}.

At the initial stage (Grade=0), all users with different features are placed within the same user interval (h₀). If the number of users in h₀ exceeds the threshold ζ(Grade), it will be equally divided into 2^{T} user intervals along each dimension, where the length of each divided dimension will be halved (lₜ=lₜ/2). ζ(Grade) determines the number of users in a user interval. When ζ(Grade) is larger, there are more users in each user interval, which cannot well reflect the unique preferences of different users. When ζ(Grade) is smaller, there are fewer users in each user interval, which may lead to inaccurate cache prediction. To achieve adaptive partitioning of user intervals and capture the potential relationships between interval users and their preferred contents, we set ζ(Grade)=α2^{Grade}, where α is a hyper-parameter. The partitioned user intervals are denoted as H={h₁, h₂, . . . , hₛ, . . . , h_{S}}, where Sis the number of user intervals. The partitioning may continue and go to the following stages (e.g., Grade=1, 2, . . . ) according to performance requirements.

### (2) Cache Space Partitioning

Allocating proper cache space for user intervals is important to improve cache performance. In this regard, several factors need to be considered when allocating cache space, including the number of users, user activities, and memory access intervals. For example, younger users prefer richer types of contents and show higher activities, while older users may focus on limited contents and exhibit lower activities.

Specifically, in the partitioned user interval hₛ, the number of users is donated as num(hₛ). The user activity and memory access interval are defined as

$$active ( {h}_{s} ) = \frac{r e {q}_{s}}{r e {q}_{m}} \qquad ( 6 )$$

$$diverge ( {h}_{s} ) = \frac{Γ ( {h}_{s} )}{I} \qquad ( 7 )$$

where reqₛ is the number of user requests and T (hₛ) is the memory access interval of hₛ.

Considering the above factors, the size of cache space allocated to hₛ is defined as

$${cache}_{s} = \frac{φ ( num ( {h}_{s} ) , active ( {h}_{s} ) , diverge ( {h}_{s} ) ) \times {cache}_{m}}{{\sum }_{s = 1}^{S} φ ( num ( {h}_{s} ) , active ( {h}_{s} ) , diverge ( {h}_{s} ) )} \qquad ( 8 )$$

where cacheₘ indicates the size of cache space on the MEC node connected to hₛ.

### B. VQ-VAE-based Content Popularity Prediction

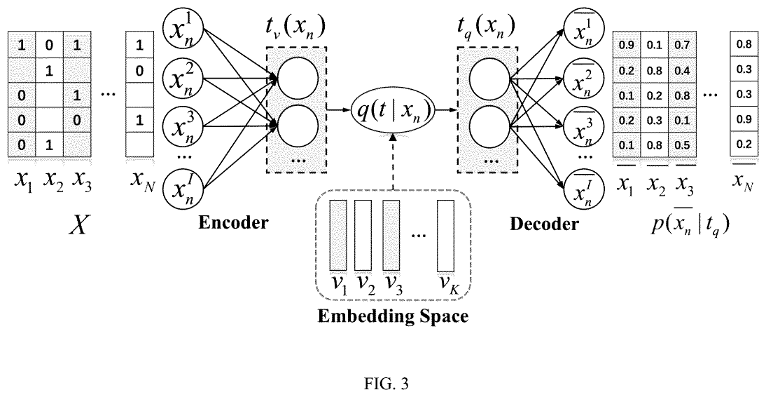

As a classic unsupervised learning method, the Variational Auto-Encoder (VAE) uses continuous variables in hidden layers to reconstruct the compressed input data, then the data clustered in the latent space. However, when facing continuous variables in hidden layers, the VAE is prone to posterior the collapse issue, which severely affects the learning and reconstruction of the original data distribution, leading to inaccurate popularity prediction. To address this issue, the VQ-VAE adopts learnable discrete vectors to form the implicit embedding space, replacing the hidden layers in the classic VAE. When predicting the content popularity, the VQ-VAE aims to find the vector in the implicit embedding space with the closest distance to the output encoding of the encoder network, and then it reconstructs the mapped vector via the decoder network. FIG. 3 illustrates the VQ-VAE-based content popularity prediction.

Specifically, the VQ-VAE learns the implicit distribution in the user request matrix X, aiming to obtain future user requests in the reconstructed matrix output by the decoder. The user request matrix X contains historical information of user-requested contents on MEC nodes, which is defined as

$$X = {[ {x}_{1} , … , {x}_{n} , … , {x}_{N} ]}^{T} ∈ {ℝ}^{N \times I} \qquad ( 9 )$$

where 1≤n≤N and with n presenting the number of users connected to a MEC node. xₙ=[xₙ¹, . . . , xₙⁱ, . . . , xₙ^{I}]^{T} indicates the content request record of the user n, where 1≤i≤I and i is the index of the content library. xₙⁱ=1 indicates the successful content request. xₙⁱ=0 indicates either a failed content request or the content that is not of interest, and these two cases are hard to be distinguished, leading to inaccurate prediction. To solve this issue, we supplement and calibrate the matrix X.

In VQ-VAE, the implicit embedded space is defined as v∈ [symbol] ^{K×D}, where K is the space size and D is the dimension of the embedded vector. Thus, there are K embedded vectors vₖ∈ [symbol] ^{D} (k∈1, 2, 3, . . . , K). As shown in FIG. 3, the VQ-VAE inputs xₙ and outputs tᵥ(xₙ) via the encoder network. Next, discrete hidden variable t is calculated by the nearest neighbor algorithm, and the posterior probability distribution q(t|xₙ) is one-hot encoding, which is defined as

$$q ( t = k \vert {x}_{n} ) = \{ \begin{matrix}1 , & if k = arg {min}_{j} ‖ {t}_{v} ( {x}_{n} ) - {v}_{j} {‖}_{2} \\ 0 , & otherwise\end{matrix} \qquad ( 10 )$$

The input of the decoder is defined as

$${t}_{q} ( {x}_{n} ) = {v}_{k} \qquad ( 11 )$$

where k is the index of the decoder input, and it is defined as

$$k = ( arg {min}_{j} {‖ {t}_{v} ( {x}_{n} ) - {v}_{j} ‖}_{2} \qquad ( 12 )$$

To address the problem of gradient collapse caused by introducing the implicit embedded space, we replicate the gradient ∇_{z}L from the decoder network to the encoder network during the back-propagation.

When training the VQ-VAE, the loss function is defined as

$$L = log p ( {x}_{n} \vert {t}_{q} ( {x}_{n} ) ) + {‖ sg [ {t}_{v} ( {x}_{n} ) ] - v ‖}_{2}^{2} + λ {‖ {t}_{v} ( {x}_{n} ) - sg [ v ] ‖}_{2 ;}^{2} \qquad ( 13 )$$

where log p(xₙ|t_{q}(xₙ)) is the reconstruction loss, aiming to optimize the encoder and decoder networks. Since the back-propagation gradient is directly replicated to the encoder network, the loss log p(xₙ|t_{q}(xₙ)) is not considered. In ∥sg[tᵥ(xₙ)]−v∥₂², L2 error is used to drive vₖ towards tᵥ(xₙ), aiming to optimize the implicit embedded space. λ∥tᵥ(xₙ)−sg[v]∥₂² is to prevent the encoder output from exceeding the scope of the implicit embedding space, where λ depends on the reconstruction loss, and sg is the stop-gradient operator that is constant with the partial derivative of 0 during the forward propagation.

Next, the log-likelihood function is defined as

$$log p ( {x}_{n} ) \approx log p ( {x}_{n} \vert {t}_{q} ( {x}_{n} ) ) p ( {t}_{q} ( {x}_{n} ) ) \qquad ( 14 )$$

According to Jensen's Inequality, Eq. (13) is rewritten as

$$log p ( {x}_{n} ) \geq log p ( {x}_{n} \vert {t}_{q} ( {x}_{n} ) ) p ( {t}_{q} ( {x}_{n} ) ) \qquad ( 15 )$$

### C. Robust Federated Deep Learning (RFDL)

There are two key components in the proposed RFDL including the residual-based detection and the similarity-based federated aggregation. The residual-based detection is to detect adversarial model updates by parameter ranking. The similarity-based federated aggregation is to avoid the destruction of the globally-shared model by adversarial updating and generate a robust and accurate prediction model of content popularity in complex MEC environments.

### (1) Residual-Based Detection

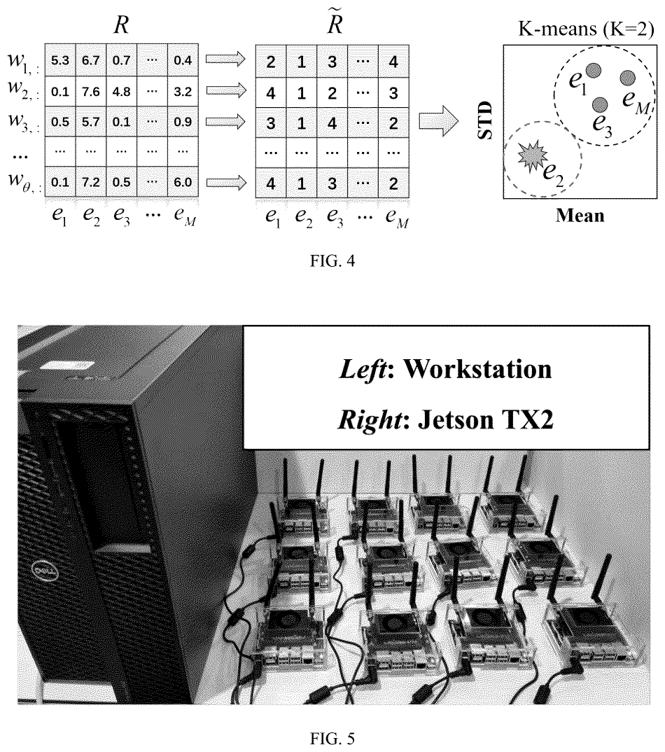

For classic FL training, some adversarial model updates may happen, severely affecting model robustness. To address this issue, we design a parameter ranking matrix \tilde{R} to detect the adversarial updating. Typically, adversarial updates may reveal some distinctive features in the ranking domain such as unusual mean and standard deviation. As shown in FIG. 4, we first combine the model parameters from all MEC nodes into a matrix R∈ [symbol] ^{M×θ}, which is defined as

$${R}_{m , :} = \frac{‖ {w}_{m}^{( ⋆ )} − {w}_{m}^{( 0 )} ‖}{M} \qquad ( 16 )$$

$${w}_{m}^{( ⋆ )} = {w}_{m}^{( 0 )} − \frac{1}{M} {\sum }_{m = 1}^{M} \frac{\partial L ( {w}_{m} ; {d}_{m} )}{\partial w} \qquad ( 17 )$$

$${w}_{m}^{( 0 )} − {w}_{m}^{( ⋆ )} = \frac{1}{M} {\sum }_{m = 1}^{M} \frac{\partial L ( {w}_{m} ; {d}_{m} )}{\partial w} \qquad ( 18 )$$

where the local training model is parameterized by wₘ, wₘ^{(*)} is the updated local model, and dₘ is the training data.

Next, we arrange the elements of each column in R in descending order, retain their sorted positions, and transform them into \tilde{R}. For example, R(5.3, 6.7, 0.7, 0.4)→\tilde{R}(2, 1, 3, 4). Specifically, the mean and standard deviation (STD) of \tilde{R} are defined as

$${mean}_{m} = \frac{1}{θ} {\sum }_{ϑ = 1}^{θ} {\tilde{R}}_{m ,} ϑ \qquad ( 19 )$$

$${std}_{m} = \sqrt{\frac{1}{θ} {\sum }_{ϑ = 1}^{θ} {( {\tilde{R}}_{m , ϑ} - {mean}_{m} )}^{2}} \qquad ( 20 )$$

Following the mean and STD, we can divide the normal and adversarial model updates into two clusters through the K-means, where the adversarial model updates can be easily identified by the proposed residual-based detection. Thus, the MEC nodes that offer normal model updates can be filtered, denoted by E′={e₁, e₂, . . . , e_{M′}}.

### (2) Similarity-Based Federated Aggregation

To avoid the model destruction caused by adversarial model updates, we design a similarity-based federated aggregation method. Specifically, we adopt the canonical correlation analysis (CCA) to measure the similarity between the model updates of each MEC node and the average one, which determines the weights of different model updates when performing federated aggregation. This process is described as

$${w}^{r + 1} = ( 1 - β ) {w}^{r} + β {\sum }_{m = 1}^{{M}^{′}} \frac{{w}_{m}^{r}}{\vert d \vert} * τ \qquad ( 21 )$$

where τ indicates the similarity score.

By integrating the residual-based detection with similarity-based federated aggregation, we propose a novel RFDL, whose key steps are given in Algorithm 1.
Update in cloud data center. First, we initialize the FL communication round rₘₐₓ and global prediction model of content popularity w^{(r)} (Line 2). For every FL communication round, MEC nodes update their local models in parallel (Lines 4˜6). Next, the residual-based detection is to capture adversarial model updates and obtain the MEC nodes E′ that provide normal model updates (Lines 7˜10). Finally, the globally-shared model is generated by the similarity-based federated aggregation and distributed to MEC nodes (Line 11).
Update in each MEC node. First, we initialize the training epoch cₘₐₓ, mini-batch B, and learning rate η (Line 14). With the input of the globally-shared model w^{(r)}, each MEC node starts its local training (Line 15). For every epoch, the VQ-VAE adopts the mini-batch to train and update the local model with the Adam optimizer (Lines 17˜19). After local training, each MEC node uploads its latest local model to the cloud data center (Line 21).

Algorithm 1: The proposed RFDL

| | |
|---|---|
| 1 | # Update in cloud data center. |
| 2 | Initialize: the FL communication round [symbol] ₘₐₓ and |
| | global prediction model of content popularity w^{(r)}. |
| 3 | for round r = 1, 2, ..., [symbol] ₘₐₓ do |
| 4 | \| for cₘ ∈ E in parallel do |
| 5 | \| \| wₘ^{(r+} [symbol] ⁾ ←MEC node updates(w^{(r)} [symbol] m); |
| 6 | \| end |
| 7 | \| Construct R by Eq. (16) and convert it to [symbol] ; |
| 8 | \| Calculate mean and std of R by Eqs. (19) and |
| | \| (20); |
| 9 | \| Classify model updates by the K-means; |
| 10 | \| Obtain E′ that provides normal model updates; |
| 11 | \| Generate the globally-shared model by Eq. (21) |
| | \| and distribute it to MEC nodes; |
| 12 | end |
| 13 | # Update in each MEC node. |
| 14 | Initialize: the training epoch cₘₐₓ, mini-batch B, and |
| | learning rate η. |
| 15 | Input: the globally-shared model w^{(r)}. |
| 16 | for epoch c = 1, 2, ..., cₘₐₓ do |
| 17 | \| for batch b ∈ B do |
| 18 | \| \| Update VQ-VAE parameters: |
| | \| \| wₘ^{(r+} [symbol] ⁾ ← w^{(r)} − η∇L(w^{(r)}; b); |
| 19 | \| end |
| 20 | end |
| 21 | Upload wₘ^{(r+} [symbol] ⁾ to the cloud data center. |

[symbol]

indicates data missing or illegible when filed

D. Proactive Cache Replacement with RFDL

Based on the proposed RFDL, we design a proactive cache replacement strategy with multi-edge collaboration. The key steps are given in Algorithm 2. For each MEC node, we initialize the cache space cache temp and set of user intervals H through the multi-dimensional cache space partitioning (Line 2). While cacheₜₑₘₚ≥0, Algorithm 1 is called to predict and sort the content popularity, and the user-interest contents will be placed into the temporary cache library Cₜₑₘₚ (Line 4). To avoid the cache redundancy caused by overlapping userinterest contents in different intervals, we replace Cₜₑₘₚ by Cₛ that selects cacheₕ most popular contents in the current user interval hₛ from Cₜₑₘₚ (Lines 5˜7). Next, we remove the duplicates in the cache library Cₘ on each MEC node and update the available cache space (Lines 8˜9). The above steps will be iterated until the cache space is fully occupied.

Next, we first introduce the real-world experiment setup. Next, we evaluate the proposed RoCoCache through extensive comparative experiments.

Algorithm 2: RFDL-based proactive cache replacement

| | |
|---|---|
| 1 | for cₘ ∈ E in parallel do |
| 2 | \| Initialize: the cache space cacheₜₑₘₚ = cacheₐₗₗ |
| | \| and set of user interval H. |
| 3 | \| while cacheₜₑₘₚ ≥ 0 do |
| 4 | \| \| Cₜₑₘₚ ← Call Algorithm 1 to predict and sort |
| | \| \| the content popularity; |
| 5 | \| \| for h = 1, 2, ..., S do |
| 6 | \| \| \| C [symbol] ← Select cache [symbol] most popular contents |
| | \| \| \| in the current user interval h [symbol] from Cₜₑₘₚ; |
| 7 | \| \| end |
| 8 | \| \| Remove duplicates: Cₘ ← unique(Σₕ₌₁^{S} Cₕ); |
| 9 | \| \| Update the available cache space: |
| | \| \| cacheₜₑₘₚ = cacheₜₑₘₚ − cacheₕ; |
| 10 | \| end |
| 11 | end |

[symbol]

indicates data missing or illegible when filed

### I. Experiment Setup

Real-world Testbed. We construct a real-world testbed that consists of a workstation and a set of Jetson TX2, as shown in FIG. 5. The workstation acts as the cloud data center, equipped with two NVIDIA Geforce GTX 3090 GPUs, one Intel (R) Xeon (R) CPU Silver 4208 @ 2.10 GHz, and 32 GB of RAM. The set of Jetson TX2 acts as MEC nodes, each MEC node is equipped with an NVIDIA Pascal GPU with 256 CUDA capable cores and a CPU cluster consisting of a 2-core Denver2 and a 4-core ARM CortexA57. The workstation and the set of Jetson TX2 are on the same LAN. Based on the FLASK web framework, we build a backend to serve the communication among the workstation and the set of Jetson TX2. Moreover, we use Ubuntu 18.04 OS with CUDA v10.0 and cuDNN v7.5.0.

Datasets. We adopt the real-world datasets of MovieLens collected by the GroupLens Research, which contains about 1 million rating information of 3883 movies by 6040 anonymous users. The datasets offer user serial numbers, movie indexes, movie ratings, timestamp labels, and user context information. Specifically, we select the user gender, age, and occupation as user features and regard the movie rating as user requests. The datasets are split into the training (70%), validation (10%), and testing (20%) sets.

Parameter Settings. Based on the above real-world testbed and datasets, we simulate the scenario of multi-edge collaborative caching that consists of one cloud data center, 5˜20 MEC nodes, and 6040 users. The cloud data center stores the complete MovieLens datasets, each MEC node is equipped with a fixed size of cache space, and users are randomly distributed in the service zone of each edge node. We implement the RoCoCache based on Python 3.8 and Tensorflow 2.4.0. Specifically, the hyper-parameter a in the multi-dimensional cache space partitioning is 512, the size of the VQ-VAE hidden embedded space K is 128, the dimension D of the embedded vector vₑ is 16, the number of FL communication rounds rₘₐₓ is 50, the batch size in VQ-VAE is 32, the number of training epochs cₘₐₓ is 300, and the learning rate η is 0.001.

Comparison Approaches. We compare the RoCoCache with the optimum and the following benchmark methods. Moreover, we conduct ablation experiments to analyze the effectiveness of the multi-dimensional cache space partitioning and collaborative caching in RoCoCache. Meanwhile, we test the training and caching efficiency of the RoCoCache.
Oracle foreknows all prior information of future user requests, and thus it can obtain the optimal cache hit rate with the limited cache space.
Random randomly selects the requested contents of users to conduct proactive caching.
Least Recently Used (LRU) eliminates the least recently used contents according to the request time of users.
Auto-Encoder (AE) first reconstructs the input data by using the encoder to compress hidden layers, and then the predicted distribution of content popularity is obtained from the output matrix.
Variational Auto-Encoder (VAE) improves the AE and uses continuous variables in hidden layers to reconstruct the compressed input data.

Attack Models. We evaluate the robustness of the RoCoCache by using the following two attack models.
Sign Flipping Attack (SFA) generates adversarial model updates by reversing the normal model updates, denoted by wₘ^{(r+1)}==μWₘ^{(r)}, where μ>0.
Gaussian Noise Attack (GNA) generates adversarial model updates by adding the Gaussian random noise to the normal model updates.

### II. Experiment Results and Analysis

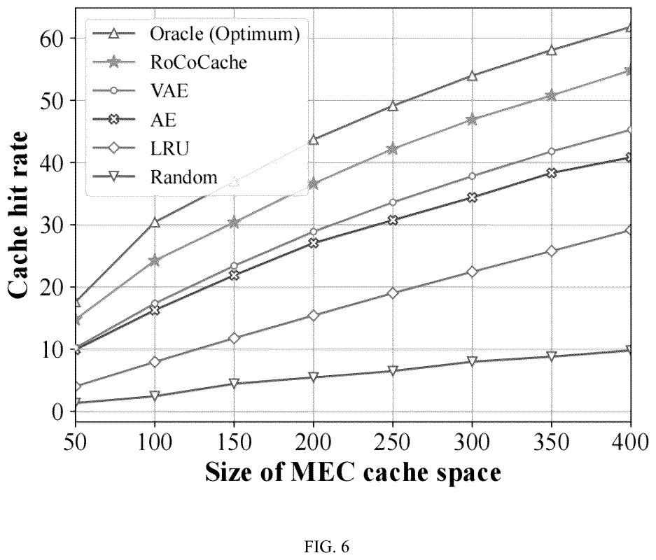

Comparison with Benchmarks. We conduct comparison experiments under different sizes of MEC cache space in terms of cache hit rate. As shown in FIG. 6, as the increasing size of MEC cache space, the cache hit rate of all methods shows a growing trend. Since the Oracle foreknows all prior information of future user requests, it achieves the theoretically-optimal result. The Random reveals the worst performance because its caching strategy is blind. The AE and VAE exhibit good cache hit rates since they compress high-dimensional user requests to low-dimensional representations and learn the potential relationships between user features and requested contents. By using clustering in the continuous hidden space, the VAE owns a better ability to reconstruct input distribution than the AE, and thus the VAE can obtain a more accurate prediction of content popularity and higher cache hit rate compared to the AE. The LRU can well react to burst and sparse content requests but struggles to handle the changeable trend of content popularity. Therefore, the cache performance of the LRU is worse than the AE and VAE. Compared to other methods, the RoCoCache shows higher cache hit rates that approximate the optimum. This is because the RoCoCache realizes the perceptual optimization of cache space by multidimensional cache space partitioning, and meanwhile solves the posterior collapse problem that happens in VAE, leading to more accurate content popularity prediction.

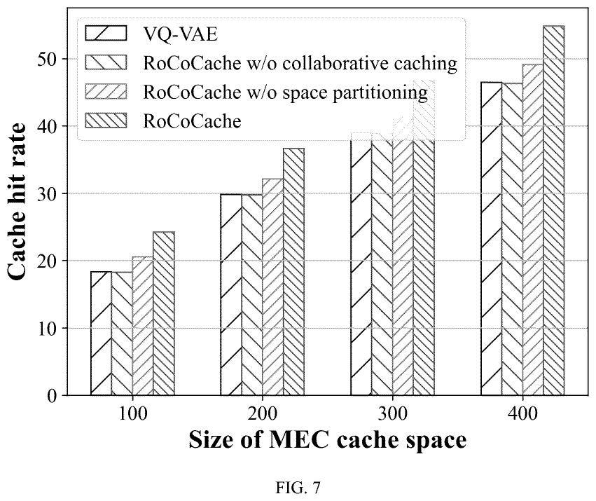

Ablation Experiments. We conduct ablation experiments to test the impact of multi-dimensional cache space partitioning and collaborative caching on the VQ-VAE-based methods. As shown in FIG. 7, the cache hit rates of all methods incline as the size of MEC cache space increases. Because the VQVAE can achieve the near-optimal result in the scenario without collaborative caching, it shows comparable performance with the RoCoCache that only uses multi-dimensional cache space partitioning. When the RoCoCache adopts collaborative caching, it can benefit from the joint optimization of multi-edge cache resources and thus achieve higher cache hit rates. It is worth noting that the RoCoCache achieves the best cache hit rate among these methods, which indicates that the multidimensional cache space partitioning can effectively assemble the common user preferences in each MEC node. Therefore, the RoCoCache maintains good cache performance in both collaborative and uncollaborative caching scenarios.

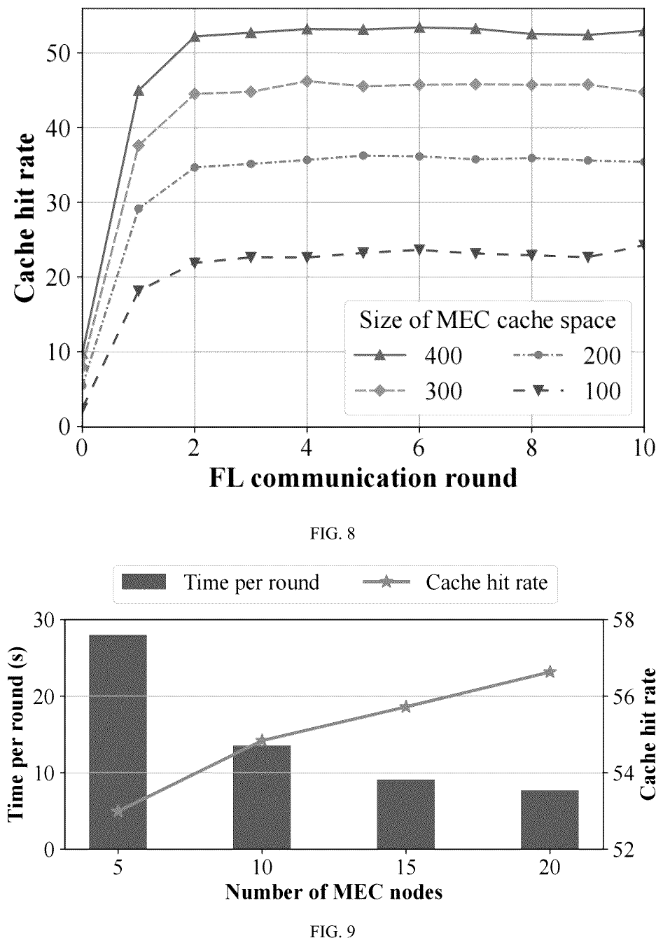

Convergence Analysis. FIG. 8 illustrates the trend of the cache performance as the increasing number of FL communication rounds, where different MEC cache space sizes are used to make comprehensive testing. At the initial stage, MEC nodes randomly select contents to store in their cache space, resulting in low cache hit rates. After one round of FL communication, the RoCoCache generates a preliminary prediction model of content popularity, and the cache hit rate is rapidly enhanced. At this time, the RoCoCache can achieve more than 80% of its optimal cache performance under the scenarios with different sizes of MEC cache space. As analyzed in FIG. 6, the size of the MEC cache space determines the growth range of cache hit rates. It is worth noting that the RoCoCache tends to converge after only six FL communication rounds under different scenarios, demonstrating the high training efficiency of the RoCoCache.

Training Efficiency. We test the training efficiency of the RoCoCache in the scenarios with different numbers of MEC nodes. As shown in FIG. 9, the per-round time of FL training decreases as the number of MEC nodes increases. When the amount of user content requests remains constant, more MEC nodes for collaborative caching can effectively enhance the training efficiency. Meanwhile, with the inclining number of MEC nodes, the RoCoCache can better capture diverse user preferences and improve the cache hit rate in multiedge collaboration. The results verify that the RoCoCache can adapt to various multi-edge scenarios while achieving excellent training efficiency and cache hit rate.

Caching Efficiency. We test the caching efficiency of different methods in the scenario with five MEC nodes in terms of the delay of content requests. The Uncollaborative indicates the RoCoCache without collaborative caching, and the Distributed only caches one copy of contents on each MEC node according to the content popularity. As shown in Table 1, the delay of content requests declines as the size of MEC cache space increases. The RoCoCache reveals the best caching efficiency because it can handle content requests via three ways and accurately predict the content popularity. The Uncollaborative does not use collaborative caching, and thus it needs to forward the requests of missing contents from local devices to the remote cloud. Moreover, due to the low cache hit rate, the Distributed needs to constantly send content requests to other MEC nodes and the remote cloud. Therefore, these two methods result in excessive delay.

TABLE I
DELAY (MS) COMPARISON OF CONTENT REQUESTS
BETWEEN THE RoCoCache AND OTHER METHODS

| MEC cache space size | 100 | 200 | 300 | 400 |
|---|---|---|---|---|
| RoCoCache | 28.2209 | 24.8851 | 21.7936 | 19.0720 |
| Uncollaborative | 28.5608 | 25.2146 | 22.3836 | 20.2478 |
| Distributed | 30.7789 | 28.2215 | 23.7301 | 20.6601 |

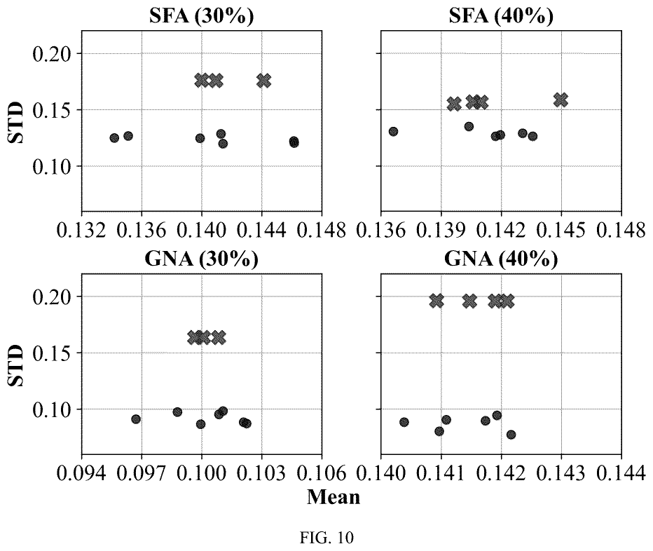

Robustness Analysis. We evaluate the robustness of the RoCoCache from two aspects. On the one hand, we test the ability of the RoCoCache to detect adversarial model updates. FIG. 10 illustrates the performance of the residualbased detection model in the scenarios with 30% and 40% proportions of adversarial model updates, where the separation between the adversarial model updates (red) and the normal model updates (blue) indicates the difference of the two updates between the gradient mean and standard deviation. For detecting the SFA, the growing proportion of adversarial model updates increases the difficulty of using residual-based detection. In this case, the RoCoCache can still distinguish adversarial model updates. For detecting the GNA, the larger proportion of Gaussian noise seriously affects the standard deviation, and the separation becomes more pronounced.

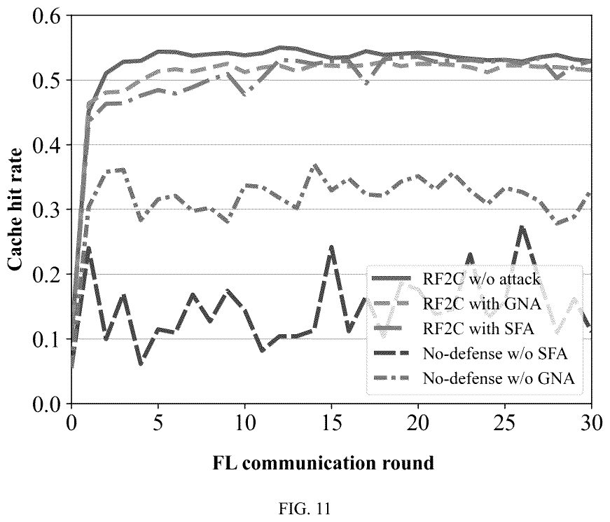

On the other hand, FIG. 11 illustrates the cache performance of the RoCoCache under different attacks and defenses when the proportion of adversarial model updates is 30%. When there is no attack, the RoCoCache achieves the ideal cache hit rate. Under the attacks of the SFA and GNA, the RoCoCache can still converge after around 20 FL communication rounds and approximate the ideal result. When there is no defense, the cache performance suffers greatly from the SFA because the sign reversion seriously destroys the federated aggregation. The SFA makes the globally-shared model invalid, and thus the cache hit rate can only be maintained at the level of random caching. Similarly, the cache performance is also significantly affected by the GNA under the no-defense situation. This is because the Gaussian noise changes the weighted mean and geometric median of the globally-shared model, increasing the difficulty of model training. The results verify the good robustness of the RoCoCache, which offers accurate identification for adversarial model updates in complex network environments and promises high model convergence.

In this application, we propose RoCoCache, a novel collaborative caching framework for multi-edge systems with RFDL. First, we design a multi-dimensional cache space partitioning mechanism to perceptually optimize the cache space of MEC nodes, offering accurate content recommendations in user classification intervals. Next, we develop a VQ-VAE-based content popularity prediction algorithm, addressing the posterior collapse and enhancing the prediction accuracy. Finally, we create a new training mode and proactive cache replacement strategy based on RFDL for better adaptability and robustness in complex network environments. Using real-world testbed and MovieLens datasets, the extensive experiments verify the effectiveness of the proposed RoCoCache. The results show that the RoCoCache achieves a higher cache hit rate than benchmark methods and approximates the optimum. Through the ablation experiments, we verify that the designs of multidimensional cache space partition and collaborative caching in RoCoCache can effectively improve the cache performance. Moreover, the RoCoCache exhibits both excellent training and cache efficiency under various scenarios with different numbers of MEC nodes and cache space sizes. Besides, the RoCoCache is able to accurately identify adversarial model updates in complex network environments, demonstrating its good robustness.

What is claimed is:

1. A Collaborative Caching Framework for Multi-edge Systems with Robust Federated Deep Learning, wherein the Collaborative Caching Framework for Multi-edge Systems which consists of M MEC nodes, each contains a MEC server and a base station, donated by the set E={e₁, e₂, . . . , eₘ, . . . , e_{M}}, and N users, donated by the set U={u₁, u₂, . . . , uₙ, . . . , U_{N}}; the caching space of MEC nodes is donated as the set C={C₁, C₂, . . . , Cₘ, . . . , C_{M}}; each user is connected to a MEC node, and they communicate with each other via the wireless link provided by the associated base station; furthermore, the communications among MEC nodes and between MEC nodes and the cloud data center are conducted via the backhaul link; the caching space status of each MEC node is periodically broadcast to the other MEC nodes within the proposed system; moreover, the content library of the cloud data center, denoted by F={f₁, f₂, . . . , fᵢ, . . . , f_{I}}, where I indicates the number of accessible contents; it is noted that users are discretely distributed in the service zone of each edge node.

2. The Collaborative Caching Framework for Multi-edge Systems with Robust Federated Deep Learning according to claim 1, wherein when the user uₙ sends a request for the content fᵢ to its connected MEC node, the workflow is given as follows:
Step 1: the current MEC node checks whether it has cached fᵢ; if fᵢ is cached, the MEC node will send it to uₙ directly; otherwise, it goes to Step 2;
Step 2: the current MEC node searches for whether there exists a collaborative MEC node that caches fᵢ; if there exists, the collaborative MEC node will forward fᵢ to the current MEC node via the backhaul link, and then fᵢ will be sent to uₙ; otherwise, it goes to Step 3;
Step 3: if no collaborative MEC node caches fᵢ, the content library in the cloud data center will provide fᵢ and forward it to the current MEC node through the backhaul link, and then fᵢ will be sent to uₙ.

3. The Collaborative Caching Framework for Multi-edge Systems with Robust Federated Deep Learning according to claim 1, wherein the popularity of fᵢ on the MEC node eₘ is defined as
$${P}_{i , m} = \frac{{req}_{i , m}}{{req}_{m}} \qquad ( 1 )$$
where red_{i,m} is the number of requests for fᵢ received by eₘ, and reqₘ is the total number of requests received by eₘ;
the proposed RoCoCache enables precise prediction of content popularity; to evaluate the prediction accuracy, the global loss function is defined as
$$J ( {w}^{( r )} ) = {\sum }_{m = 1}^{M} \frac{r e {q}_{m}}{r e q} M S {E}_{m} ( {w}_{m}^{( r )} ) \qquad ( 2 )$$
where r indicates the FL communication round, w^{(r)} is the parameter of the global prediction model, req is the total number of requests received by all MEC nodes, wₘ^{(r)} is the parameter of a local prediction model, and Mean-Square Error (MSE) is defined as
$$M S {E}_{m} ( {w}_{m}^{( r )} ) = \frac{1}{I} {\sum }_{j = 1}^{I} {( {y}_{i , m} ( {w}_{m}^{( r )} ) - {P}_{i , m} ( r ) )}^{2} \qquad ( 3 )$$
where [symbol] _{i, m}(wₘ^{(r)} is the predicted popularity value of fᵢ on eₘ and P_{i,m}(r) is the actual value;
moreover, the cache hit rate is defined as
$$H = \frac{{\sum }_{m = 1}^{M} {\sum }_{i = 1}^{M} {θ}_{m} ( {f}_{i} )}{{\sum }_{m = 1}^{M} {req}_{m}} \times 100 \% \qquad ( 4 )$$
where θₘ(fᵢ) indicates whether eₘ caches the content requested by users or not, and it is defined as
$${θ}_{m} ( {f}_{i} ) = \{ \begin{matrix}1 , & if {f}_{i} in {C}_{m} \\ 0 , & otherwise\end{matrix} . \qquad ( 5 )$$

4. The Collaborative Caching Framework for Multi-edge Systems with Robust Federated Deep Learning according to claim 1, wherein proposing a user partitioning method based on multi-dimensional user features including gender, age, and occupation, which are mapped to coordinate axes, denoted by Θ={l₁, l₂, . . . , lₜ, . . . , l_{T}}; at the initial stage (Grade=0), all users with different features are placed within the same user interval (h₀); if the number of users in h₀ exceeds the threshold ζ(Grade), it will be equally divided into 2^{T} user intervals along each dimension, where the length of each divided dimension will be halved (lₜ=lₜ/2); ζ(Grade) determines the number of users in a user interval; when ζ(Grade) is larger, there are more users in each user interval, which cannot well reflect the unique preferences of different users; when ζ(Grade) is smaller, there are fewer users in each user interval, which may lead to inaccurate cache prediction; to achieve adaptive partitioning of user intervals and capture the potential relationships between interval users and their preferred contents, we set ζ(Grade)=α2^{Grade}, where α is a hyper-parameter; the partitioned user intervals are denoted as H={h₁, h₂, . . . , hₛ, . . . , h_{S}}, where Sis the number of user intervals; the partitioning may continue and go to the following stages (e.g., Grade=1, 2, . . . ) according to performance requirements.

5. The Collaborative Caching Framework for Multi-edge Systems with Robust Federated Deep Learning according to claim 1, wherein the user activity and memory access interval are defined as
$$active ( {h}_{s} ) = \frac{{req}_{s}}{{req}_{m}} \qquad ( 6 )$$
$$diverge ( {h}_{s} ) = \frac{Γ ( {h}_{s} )}{I} \qquad ( 7 )$$
where reqₛ is the number of user requests and Γ(hₛ) is the memory access interval of hₛ;
considering the above factors, the size of cache space allocated to hₛ is defined as
$${cache}_{s} = \frac{φ ( num ( {h}_{s} ) , active ( {h}_{s} ) , diverge ( {h}_{s} ) ) \times {cache}_{m}}{{\sum }_{s = 1}^{S} φ ( num ( {h}_{s} ) , active ( {h}_{s} ) , diverge ( {h}_{s} ) )} \qquad ( 8 )$$
where cacheₘ indicates the size of cache space on the MEC node connected to hₛ.

6. The Collaborative Caching Framework for Multi-edge Systems with Robust Federated Deep Learning according to claim 1, wherein the user request matrix X contains historical information of user-requested contents on MEC nodes, which is defined as
$$X = {[ {x}_{i} , … , {x}_{n} , … , {x}_{N} ]}^{T} ∈ {ℝ}^{N \times I} \qquad ( 9 )$$
where 1≤n≤N and with n presenting the number of users connected to a MEC node; xₙ=[xₙ¹, . . . , xₙⁱ, . . . , xₙ^{I}]^{T} indicates the content request record of the user n, where 1≤i≤I and t is the index of the content library; xₙⁱ=1 indicates the successful content request; xₙⁱ=0 indicates either a failed content request or the content that is not of interest, and these two cases are hard to be distinguished, leading to inaccurate prediction; to solve this issue, we supplement and calibrate the matrix X;
in VQ-VAE, the implicit embedded space is defined as v∈ [symbol] ^{K×D}, where K is the space size and D is the dimension of the embedded vector; thus, there are K embedded vectors vₖ∈ [symbol] ^{D} (k∈1, 2, 3, . . . . K); the VQ-VAE inputs xₙ and outputs tᵥ(xₙ) via the encoder network; next, discrete hidden variable t is calculated by the nearest neighbor algorithm, and the posterior probability distribution q(t|xₙ) is one-hot encoding, which is defined as
$$q ( t = k \vert {x}_{n} ) = \{ \begin{matrix}1 , & for k = {argmin}_{j} {‖ {t}_{v} ( {x}_{n} ) - {v}_{j} ‖}_{2} \\ 0 , & otherwise\end{matrix} \qquad ( 10 )$$
the input of the decoder is defined as
$${t}_{q} ( {x}_{n} ) = {v}_{k} \qquad ( 11 )$$
where k is the index of the decoder input, and it is defined as
$$k = {argmin}_{j} {‖ {t}_{v} ( {x}_{n} ) - {v}_{j} ‖}_{2} \qquad ( 12 )$$
to address the problem of gradient collapse caused by introducing the implicit embedded space, we replicate the gradient ∇_{z}L from the decoder network to the encoder network during the back-propagation;
when training the VQ-VAE, the loss function is defined as
$$L = log p ( {x}_{n} \vert {t}_{q} ( {x}_{n} ) ) + {‖ sg [ {t}_{v} ( {x}_{n} ) ] - v ‖}_{2}^{2} + λ {‖ {t}_{v} ( {x}_{n} ) - sg [ v ] ‖}_{2}^{2} , \qquad ( 13 )$$
where log p(xₙ|t_{q}(xₙ)) is the reconstruction loss, aiming to optimize the encoder and decoder networks; since the back-propagation gradient is directly replicated to the encoder network, the loss log p(xₙ|t_{q}(xₙ)) is not considered; in ∥sg[tᵥ(xₙ)]−v∥₂², L2 error is used to drive vₖ towards tᵥ(xₙ), aiming to optimize the implicit embedded space; λ∥tₙ(xₙ)−sg[v]∥₂² is to prevent the encoder output from exceeding the scope of the implicit embedding space, where λ depends on the reconstruction loss, and sg is the stop-gradient operator that is constant with the partial derivative of 0 during the forward propagation;
next, the log-likelihood function is defined as
$$log p ( {x}_{n} ) \approx log p ( {x}_{n} \vert {t}_{q} ( {x}_{n} ) ) p ( {t}_{q} ( {x}_{n} ) ) \qquad ( 14 )$$
according to Jensen's Inequality, Eq. (13) is rewritten as
$$log p ( {x}_{n} ) \geq log p ( {x}_{n} \vert {t}_{q} ( {x}_{n} ) ) p ( {t}_{q} ( {x}_{n} ) ) . \qquad ( 15 )$$

7. The Collaborative Caching Framework for Multi-edge Systems with Robust Federated Deep Learning according to claim 1, wherein first combine the model parameters from all MEC nodes into a matrix R∈ [symbol] ^{M×θ}, which is defined as
$${R}_{m , :} = \frac{‖ {w}_{m}^{\text{(*} )} - {w}_{m}^{( 0 )} ‖}{M} \qquad ( 16 )$$
$${w}_{m}^{\text{(*} )} - {w}_{m}^{( 0 )} - \frac{1}{M} {\sum }_{m = 1}^{M} \frac{\partial L ( {w}_{m} ; {d}_{m} )}{\partial w} \qquad ( 17 )$$
$${w}_{m}^{( 0 )} - {w}_{m}^{\text{(*} )} - \frac{1}{M} {\sum }_{m = 1}^{M} \frac{\partial L ( {w}_{m} ; {d}_{m} )}{\partial w} \qquad ( 18 )$$
where the local training model is parameterized by wₘ, wₘ^{(*)} is the updated local model, and dₘ is the training data;
next, we arrange the elements of each column in R in descending order, retain their sorted positions, and transform them into \tilde{R}; for example, R(5.3, 6.7, 0.7, 0.4)→\tilde{R}(2, 1, 3, 4); specifically, the mean and standard deviation (STD) of \tilde{R} are defined as
$${mean}_{m} = \frac{1}{θ} {\sum }_{ϑ = 1}^{θ} {\tilde{R}}_{m , ϑ} \qquad ( 19 )$$
$${std}_{m} = \sqrt{\frac{1}{θ} {\sum }_{ϑ = 1}^{θ} {( {\tilde{R}}_{m , ϑ} - {mean}_{m} )}^{2}} \qquad ( 20 )$$
following the mean and STD, we can divide the normal and adversarial model updates into two clusters through the K-means, where the adversarial model updates can be easily identified by the proposed residual-based detection; thus, the MEC nodes that offer normal model updates can be filtered, denoted by E′={e₁, e₂, . . . , e_{M′}}; to avoid the model destruction caused by adversarial model updates, we design a similarity-based federated aggregation method; specifically, we adopt the canonical correlation analysis (CCA) to measure the similarity between the model updates of each MEC node and the average one, which determines the weights of different model updates when performing federated aggregation; this process is described as
$${w}^{r + 1} = ( 1 - β ) {w}^{r} + β {\sum }_{m = 1}^{{M}^{′}} \frac{{w}_{m}^{r}}{\vert d \vert} * τ \qquad ( 21 )$$
where τ indicates the similarity score.

8. The Collaborative Caching Framework for Multi-edge Systems with Robust Federated Deep Learning according to claim 1, wherein based on the proposed RFDL, design a proactive cache replacement strategy with multi-edge collaboration; for each MEC node, initialize the cache space cacheₜₑₘₚ and set of user intervals H through the multi-dimensional cache space partitioning; while cacheₜₑₘₚ≥0, and the user-interest contents will be placed into the temporary cache library Cₜₑₘₚ; to avoid the cache redundancy caused by overlapping userinterest contents in different intervals, replace Cₜₑₘₚ by Cₛ that selects cacheₕ most popular contents in the current user interval hₛ from Cₜₑₘₚ; next, remove the duplicates in the cache library Cₘ on each MEC node and update the available cache space; the above steps will be iterated until the cache space is fully occupied.
